(19) United States
(12) Patent Application Publication
(10) Pub. No.: US 2005/0085931 A1
(43) Pub. Date: Apr. 21, 2005

(54) Online ATM transaction with digital certificate

(76) Inventor: Tandy Willeby, Dallas, TX (US)

Correspondence Address: HOWISON & ARNOTT, L.L.P, P.O. BOX 741715, DALLAS, TX, 75374-1715, US

(21) Appl. No.: 10/375,290

(22) Filed: Feb. 27, 2003

Related U.S. Application Data
(63) Continuation of application No. PCT/US01/27342, filed on Aug. 31, 2001.
(60) Provisional application No. 60/229,400, filed on Aug. 31, 2000.

(51) Int. Cl. G05B 19/42

(52) U.S. Cl. 700/89

(57) ABSTRACT

A system and method are provided for performing a secure ATM debit transaction for a buyer making a payment to a seller over the Internet. The system comprises an ATM debit network, a seller web site, a transaction computer system, and a software program. The ATM debit network links together a plurality of banks, financial institutions, and ATM machines. The seller web site is accessible to the buyer via the Internet. The transaction computer system is adapted to be communicably coupled to the seller web site and the ATM debit network as needed to perform the secure ATM debit transaction. The software program on the transaction computer system is adapted to authorize and facilitate the secure ATM transaction between the seller and the buyer using at least one digital certificate. When the secure ATM transaction is authorized by at least authenticating the at least one digital certificate, the software program submits a debit request to the ATM debit network corresponding to the secure ATM debit transaction.

### CROSS-REFERENCE TO RELATED APPLICATIONS

This application is a continuation of international application number PCT US01/27342, filed Aug. 31, 2001. Under 35 U.S.C. § 119(e), this application claims the benefit of commonly owned U.S. Provisional Patent Application having Ser. No. 60/229,400 entitled SYSTEM FOR ONLINE AUTOMATED TELLER TRANSACTIONS filed on Aug. 31, 2000, which is also hereby incorporated by reference.

### TECHNICAL FIELD OF THE INVENTION

The present invention relates to a system and method for performing bank account debit payment transactions using a digital certificate. In one aspect, it relates to a system and method of verifying an ATM transaction using a digital certificate for use in electronic commerce over the Internet.

### BACKGROUND OF THE INVENTION

Authentication systems are often used for security purposes to verify the authenticity of one or more parties during a transaction. Traditionally, authentication systems have been manual, involving simple personal recognition or quick verification of the party via some form of additional identification. A typical authentication process occurs, for example, when purchasing an item with a personal check. The sales clerk will process the check only if he or she recognizes the person writing the check or if that person presents another piece of identification (e.g., driver's license) to verify the authenticity of that person who is offering the check. Another common manual authentication process might occur in an apartment building or at work where a person is authenticated by a security guard or receptionist through visual recognition.

Some authenticating systems are electronic. For example, a common electronic authentication system is used in an automated teller machine (ATM). Bank members are issued special ATM cards for use in the ATMs to permit automated and/or remote access to and/or withdrawals from the member's bank account. The ATM cards that are primarily in use today are plastic cards having a single magnetic strip on one side. The magnetic strip typically contains information regarding the bank, the member, and his or her account number. To guard against unauthorized access, the member is also assigned or asked to choose a multi-digit password or personal identification number (PIN). In use, the member inserts the magnetic-strip card into the ATM and enters his or her four-digit PIN. The PIN authenticates for the ATM that the person standing at the ATM is the member who owns the inserted ATM card (or an authorized person representing that member).

ATM cards or bank debit cards are now being accepted by many stores and merchants for the purchase of merchandise in a store. Magnetic-strip cards are limited, however, in that comparison of the PIN number recorded on the magnetic-strip card with the PIN number entered by the card user most often requires the purchaser to be in the merchant's physical presence.

Personal accounts have become an onmipresent aspect of contemporary society, associated with almost every aspect of our lives. Personal accounts are associated with, for example, telephone calling cards, checking and savings accounts in banks, computer networks, and credit cards. Typically, account security is maintained (and unauthorized access prevented) by use of a password or PIN.

Account security is typically maintained by requiring two separate steps for account access. First, the account number must be entered. Second, a password or PIN associated with the account must be entered as well. The account number is typically not concealed (i.e., it may be printed on the telephone calling card or credit card, or it may be recorded on a magnetic strip affixed to the card which is read by an associated card reader) and may be considered, at least for security purposes, to be readily accessible. In contrast, a password or PIN is not supposed to be readily accessible. Rather, a user is typically instructed to memorize and not write down a password or PIN to prevent inadvertent disclosure of the password or PIN. By keeping the password or PIN confidential, unauthorized access to an account is usually prevented.

For example, a telephone calling card number may be provided by keying in the number on a telephone keypad or, in some circumstances, sliding the telephone calling card through a magnetic card reader attached to a specially equipped telephone. The account number is printed on the telephone calling card, and accordingly is readily accessible to any individual looking at the telephone calling card. However, merely knowing the account number sometimes does not allow someone to use the telephone calling card when a caller also has to know the PIN associated with the telephone calling card before a call may be placed using the telephone calling card. Hence in theory, someone who steals such a telephone calling card or merely knows the account number printed on the telephone calling card cannot make fraudulent telephone calls using the telephone calling card account because only the authorized user knows the PIN necessary to activate the account.

Similarly, an ATM access card or debit card often has at least one account number associated with it that is normally recorded on the magnetic strip affixed to the card and is read when the card is inserted into or swiped at an ATM. Again, unauthorized use of the card (and therefore unauthorized account access) is usually prevented by requiring entry of a PIN before an account identified on the card can be accessed to, for example, withdraw money from the account. The owner of the ATM access card is normally instructed to memorize the PIN and not write it down to prevent an unauthorized user from learning the PIN.

Computer networks and databases also often have user accounts and associated passwords. For example, a user may have an electronic mail account or, as is increasingly often the case, the user may have a personal account associated with a web page accessed through the Internet. Typically, the user's account number and password or PIN are needed before access to an account or a restricted-access web page is granted. For example, a computer user may have a stock trading account with a stock broker that maintains a web page. The user's account is not accessible without entry of an identification number, which is normally keyed in by the user at a remote terminal. As with other multiple level security systems using passwords or PINs, the identification number may be detected by an observer. In this case, the observer may be simply watching the keyboard or, alternatively, the observer may be using a so-called “sniffer” to observe the network traffic.

In another application, a PIN or password is often used in connection with accessing voice mail. In a typical voice mail system, a user will enter the voice mail account number, typically the user's extension number, and then will be prompted to enter an access code of some kind. It is only by entering the appropriate access code (a PIN or password) that the user is able to listen to his or her voice mail. Thus, the user is able to maintain a degree of confidentiality with respect to his or her voice mail.

However, each of these applications suffers from a common flaw. A casual observer or a dedicated intruder can detect the supposedly secret personal identification number or password, either by direct observation or by repeated trial attempts. Having determined what the personal identification number or password is, an unauthorized person can obtain access to the account with relative ease, having bypassed one of the security mechanisms intended to prevent such abuse.

These access problems are exacerbated when an account is accessed over a computer system (e.g., electronic commerce over the Internet). In this case, both the account number and the passcode or PIN are directly entered into the computer system by the user, generally without the use of a magnetic-strip card or other medium, so they are both more easily intercepted. Further, there now exist many different means for capturing and recording keystrokes on a computer system, so that they can be later analyzed for account numbers and passcodes. Even more troublesome is the present capability to track the motion of a mouse or cursor on a graphical user interface (GUI) screen, and to record the screen location of touch-screen inputs, so that account numbers and passcodes can be determined my reconstructing the authorized user's actions on the GUI screen.

Also, if a security system or authentication method is too complex or too time consuming, it will sometimes discourage an authorized user from dealing using it. In other words, the user may turn to simpler or more convenient sites out of frustration or anger.

Hence, there is a need for either an alternative way to prevent the unauthorized use and access to a user's bank account for ATM or debit payments over the Internet, or a way to add an additional security measure to the currently available security measures, but without requiring too much burden or inconvenience for the user.

All references cited herein are incorporated by reference to the maximum extent allowable by law. To the extent a reference may not be fully incorporated herein, it is incorporated by reference for background purposes, and indicative of the knowledge of one of ordinary skill in the art.

### SUMMARY OF THE INVENTION

The problems and needs outlined above are largely solved and met by the present invention. In accordance with one aspect of the present invention, a system for performing an ATM debit transaction over the Internet is provided. The system comprises a transaction computer system adapted to be communicably coupled to each of a payee computer system and an ATM debit network as needed during the ATM debit transaction. The transaction computer system has software adapted to authenticate an identity of a payor using a payor digital certificate provided by the payor and adapted to debit funds from a bank account of the payor via the ATM debit network if the identity of the payor is authenticated by a decryption of the payor digital certificate.

In accordance with another aspect of the present invention, a system for transacting electronic commerce payments over the Internet is provided. The system comprises a bank account debit network, a payee computer system, a payor computer system, a transaction computer system, and a software program. The bank account debit network links together a plurality of financial institutions. The payee computer system is communicably coupled to the Internet. The payor computer system is communicably coupled to the Internet, such that the payor computer system can be communicably coupled to the payee computer system via the Internet. The transaction computer system is communicably coupled to the payee computer system and the bank account debit network. The software program on the transaction computer system is adapted to authorize a bank account debit transaction between the payee computer system and the payor computer system using at least one digital certificate exchange for at least partial authorization of the bank account debit transaction. Also, the software program is adapted to submit the bank account debit transaction to the bank account debit network for debiting money from a bank account of a payor if the bank account debit transaction has been authenticated and authorized using the at least one digital certificate exchange.

In accordance with yet another aspect of the present invention, a system for performing a secure ATM transaction for a buyer making a payment to a seller over the Internet is provided. The system comprises an ATM network, a seller web site, a transaction computer system, and a software program. The ATM network links together a plurality of banks. The seller web site is accessible to the buyer via the Internet. The transaction computer system is adapted to be communicably coupled to the seller web site and the ATM network as needed to perform the secure ATM transaction. The software program on the transaction computer system is adapted to authorize and facilitate the secure ATM transaction between the seller and the buyer using at least one digital certificate, and when the secure ATM transaction is authorized, the software program is also adapted to submit a debit request to the ATM network corresponding to the secure ATM transaction.

In accordance with still another aspect of the present invention, a system for authenticating identities of parties to an ATM debit transaction occurring over the Internet is provided. The system comprises a transaction computer system located remotely from a first computer system of a first party to the ATM debit transaction. The transaction computer system comprises a software program adapted to authenticate the identity of the first party using a digital certificate presented to the transaction computer system by the first party. The transaction computer system is adapted to be communicably coupled to an ATM debit network as needed. The first computer system is adapted to be communicably coupled to the transaction computer system as needed. A second computer system of a second party to the ATM debit transaction communicates with the first computer system via the Internet when the ATM debit transaction is initiated.

In accordance with another aspect of the present invention, a method of performing a bank account debit transaction over the Internet is provided. The method comprises the following steps, the order of which may vary: (i) requiring a payor to provide a payor digital certificate that can authenticate the identity of the payor; (ii) verifying the authenticity of the payor digital certificate on a transaction computer system; and (iii) if the payor digital certificate is authenticated, debiting funds from a bank account of the payor via a bank account debit network, wherein the transaction computer system is communicably coupled to the bank account debit network as needed during the debiting step.

In accordance with yet another aspect of the present invention, a method of performing a bank account debit transaction over the Internet is provided. The method comprises the following steps, the order of which may vary: (i) debiting funds from a bank account of a payor via a bank account debit network; (ii) requiring a payee to provide a payee digital certificate that can authenticate the identity of the payee; (iii) verifying the authenticity of the payee digital certificate on a transaction computer system; and (iv) if the payee digital certificate is authenticated, transferring the debited funds into an account of the payee.

In accordance with still another aspect of the present invention, a method of purchasing at least one of a product, service, or property from a seller via the Internet with an ATM debit card, without requiring a buyer and the ATM debit card to be physically present at a machine, employee, or facility of the seller, is provided. The method comprises the following steps, the order of which may vary: (i) when a buyer selects a debit card payment option to pay for the at least one product, service, or property offered on a seller web site, requiring the buyer to provide a buyer digital certificate to a certificate authority to authenticate the identity of the buyer; (ii) verifying the authenticity of the buyer digital certificate; (iii) if the buyer digital certificate is authenticated, debiting funds from a bank account associated with the ATM debit card via an ATM debit network; and (iv) transferring the debited funds to an account of the seller as payment for the at least one product or service purchased by the buyer from the seller web site over the Internet.

In accordance with still another aspect of the present invention, method of selling at least one of a product, service, or property via the Internet is provided. The method comprises the following steps, the order of which may vary: (i) providing a seller web site that a buyer can access via the Internet; (ii) providing a transaction computer system, wherein the transaction computer system is adapted to be communicably coupled to a seller computer system as needed, wherein the seller computer system comprises code and data adapted to provide the seller web site, and wherein the transaction computer system is adapted to be communicably coupled to a bank account debit network; (iii) when a buyer selects a debit card payment option for an electronic commerce transaction to purchase the at least one product, service, or property offered on the seller web site, initiating a debit transaction on the transaction computer system; (iv) sending a seller digital certificate to the transaction computer system for verification of the identity of the seller; (v) determining whether the seller digital certificate is authentic by decrypting the seller digital certificate at the transaction computer system; (vi) collecting a bank account number for a bank account of the buyer; (vii) determine whether the bank account number is valid; (viii) collecting a buyer digital certificate for verification of the identity of the buyer; (ix) determining whether the buyer digital certificate is authentic by decrypting the buyer digital certificate at the transaction computer system; (x) if the buyer digital certificate and the seller digital certificate are authenticated, submitting the debit transaction to the bank account debit network; (xi) debiting funds from the bank account of the buyer via the bank account debit network; (xii) informing the seller computer system that the debit transaction was successfully executed so that the electronic commerce transaction can be completed; and (xiii) depositing the debited funds into an account of the seller.

The preferred embodiment provides a system, method, and computer program product that allows ATM debit transactions to be verified using a digital certificate, possibly located on the buyer's computer, which can be sent with each ATM debit transaction communication to authenticate the source of the communication (e.g., the buyer's computer system). Hence, the PIN that might otherwise be used in an ATM debit transaction for verification purposes may not need to be used for verification. If the buyer doesn't have a digital certificate already, a digital certificate may be issued and downloaded. The digital certificate then can be stored on the buyer's computer system.

### DESCRIPTION OF THE DRAWINGS

Other objects and advantages of the invention will become apparent upon reading the following detailed description and upon referencing the accompanying drawings, in which:

FIG. 1 is a schematic of a system in accordance with a preferred embodiment of the present invention; and

FIGS. 2A-2C show a flow chart schematic of a business method or process in accordance with the preferred embodiment of the present invention.

### DETAILED DESCRIPTION OF THE INVENTION

Referring now to the drawings, wherein like reference numbers are used herein to designate like elements throughout the various views, a preferred embodiment of the present invention is illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

The following guidelines provide at least partial definitions of some terms, phrases, and acronyms as used herein, although these guidelines are not necessarily the exclusive meanings.

The acronym “ATM” as used herein refers to an Automated Teller Machine (e.g., remote, unmanned bank machine for providing cash withdrawals), not Asynchronous Transfer Mode.

The phrases “ATM network,” “ATM debit network,” and “bank account debit network” as used herein each generically refers to: a plurality of financial institutes networked together to support the use of Automated Teller Machines; a network of multipoint DDS (dataphone digital service or digital data system) circuits linking together a plurality of Automated Teller Machines with a plurality of banks for the purpose of providing debit transactions by bank customers at Automated Teller Machines; a plurality of banks and/or financial institutes linked together over dedicated lines for the purpose of providing debit transactions at an Automated Teller Machine, or at a seller's or merchant's facility or place of doing business (e.g., store, restaurant, entertainment center, medical facility, shop); a secure banking network linking together a plurality of financial institutes for the exchange of funds between banks; a network of banks and/or financial institutions linked together for the purpose of debiting funds from a bank account of a payor and depositing these debited funds into an account of a payee; a network provided by a consortium of banks and financial institutes for allowing bank customers to withdraw money from the bank customer's bank account (e.g., checking, savings, money market accounts at a bank) to receive cash from an automated teller machine, to pay a seller for goods or services at the seller's facilities, or to pay a bill or order a product or service over the telephone; and/or any combination thereof.

The phrase “bank account” as used herein refers to a personal, business, or commercial bank account (e.g., checking, savings, money market) and it does not refer a credit card account.

The phrases “ATM transaction,” “debit transaction,” “bank account debit transaction,” “ATM debit transaction,” and “bank account withdrawal transaction” as used herein each generally refers to a transaction where funds are withdrawn from a bank account of a payor.

The terms “buyer,” “user,” “customer,” and “payor” as used herein each generally refers to the person, group, partnership, entity, agency, or organization that desires to or is making a money payment to another for whatever reason (e.g., order or purchase goods or services, pay filing fee, pay a bill, pay back a person or entity to which money is owed, pay admission for an entertainment event, make a charitable donation, purchase a lottery ticket, place a bet for a gambling or casino game, etc.), or withdrawing funds from a bank account for whatever reason.

The terms “seller,” merchant,” and “payee” as used herein each generally refers to the person, group, partnership, entity, agency, or organization that is receiving or that will receive a money payment from a buyer, user, customer, or payor for whatever reason, or that is receiving or that will receive the withdrawn funds from a buyer, user, customer, or payor for whatever reason.

The phrase “computer system” as used herein generically refers to a system that may comprise one computer unit or machine, a plurality of computer units or machines, a network of computer units or machines, a server, a database, a memory storage device, a processor, software, a printer, a monitor, and/or any combination thereof. A “computer system” can be located in one physical facility, in one box, in one rack, in a plurality of racks, in a plurality of boxes, or in a plurality of physical locations linked together with communication lines. Software or software programs loaded on, stored in, or running on a computer system may comprise one executable file, a plurality of subprograms or libraries, a plurality of components, and/or any combination thereof. Also, software or software programs loaded on, stored in, or running on a computer system may be found in a single machine, may be spread out among a plurality of machines, may be burned into a chip, board, or chip set, and/or any combination thereof.

The acronym “PKI” as used herein refers to Public Key Infrastructure, which is a way to manage public keys on a secure basis for use by widely distributed users or systems.

Generally in symmetric encryption or symmetric cryptography, the sender and recipient share a secret key, which is used both to encrypt and decrypt the message or information. Hence, the same key is used to encrypt the message or information by the sender and to decrypt the message or information by the recipient.

Generally in asymmetric encryption or asymmetric cryptography or public-private key pair encryption, different keys are used to encrypt and decrypt the message or information. A pair of numbers (keys) are related to each other by a cryptographic or mathematical formula, such that the message or information can be encrypted with a public key, transmitted in an encrypted form, and decrypted with the corresponding private key of the key pair, and vice versa.

The terms “certificate authority,” “certifying authority,” and “certification authority” as used herein are interchangeable.

The term “digital certificate” is used herein to generically refer to an encrypted data file that comprises identification information of a person or entity (e.g., person's or entity's name, person's or entity's address, person's or entity's domain information, certificate authority that issued the certificate, term of the certificate or expiration date, certificate serial number, restrictions to the use of the certificate) for the purpose of identifying, verifying, and/or authenticating the identity of the person or entity presenting the digital certificate. The digital certificate is typically encrypted with a private key of a trusted third party (i.e., a certificate authority) that issues the digital certificate. Thus, such a digital certificate encrypted with a certificate authority's private key can only be opened with the certificate authority's public key. Because such a digital certificate can only be opened with the certificate authority's public key, only the certificate authority could have issued the digital certificate. Because the certificate authority is a trusted third party, the contents of the digital certificate can likewise be trusted. Via a digital certificate a certificate authority can guarantee that one or both of the parties exchanging information digitally (e.g., over the Internet) are really who they claim to be. Hence, a digital certificate is analogous to a driver's license or passport issued by a government agency.

The term “communicably coupled” is used herein to generically refer to any connection that is adapted to carry communications, whatever the supporting technology. For example, two devices may be communicably coupled using hard-wire-type connections, such as phone lines, POTS, T1 lines, DSL, cable television network, modem, SCSI connection, fiber optic, Ethernet, twisted pair, switches, token rings, local area network, PBX, wide area network, Internet connections, etc. Also, two devices may be communicably coupled using wireless connections adapted to carry communication such as via electromagnetic waves, satellite transmission, microwaves, laser light, wireless optics (e.g., infrared), etc. Further, the term includes logical connections between two processes on the same system and processes connected by a common computing device memory space. Thus, the technology by which the communication is transmitted is not material to the meaning of communicably coupled.

Other technical terms used herein will typically have the ordinary meaning as known to one having ordinary skill in the art, and/or may be found in a technical dictionary, such as Newton's Telecom Dictionary.

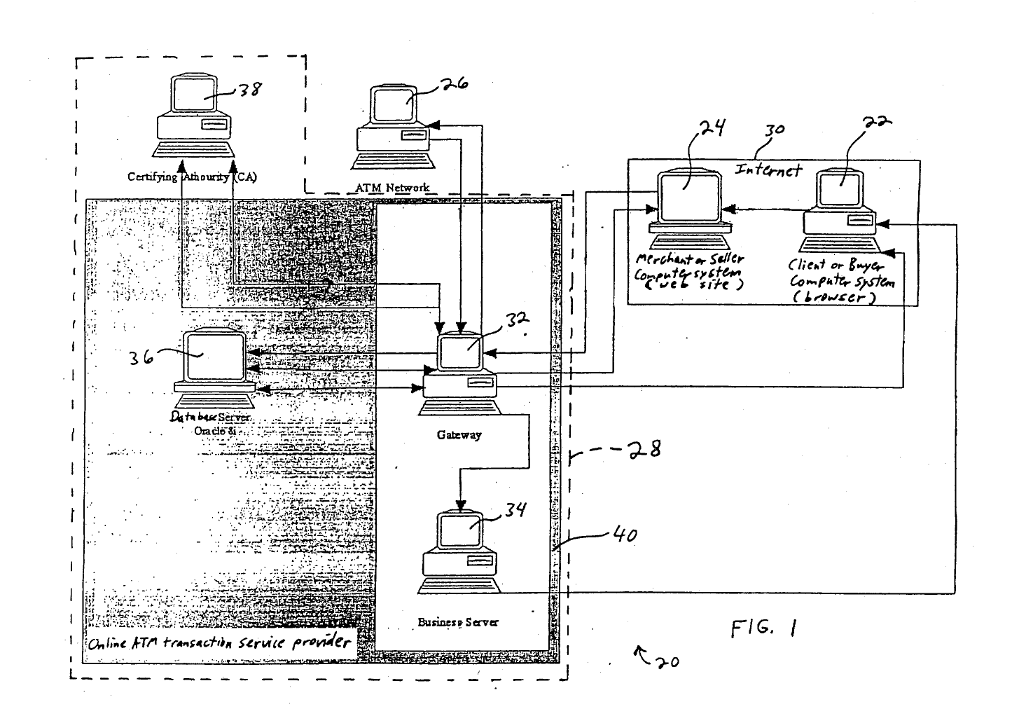

FIG. 1 is a schematic of a system 20 in accordance with a preferred embodiment of the present invention. The system 20 is adapted to perform an ATM debit transaction between a payor and a payee over the Internet using digital certificates to authenticate the identity of the parties (payor and payee) to the ATM debit transaction. In other words, the system 20 provides a way for a payor to pay a payee over the Internet with an ATM debit card, but without the payor being physically present at the payee's facility or store or in the presence of a representative or employee of the payee. Through the use of digital certificates, the present invention provides a way to conduct a secure ATM debit transaction over the Internet and authenticate the identity of the payor and/or the payee. Most buyers or customers on the Internet desire to execute a transaction or sale quickly and without a complicated procedure. But at the same time, most buyers and customers are concerned about protecting their bank accounts from fraud and theft. Hence, one of the goals of the system 20 is to prevent fraudulent use or theft of bank account information for transactions occurring over the Internet while also keeping the process relatively simple and convenient for the clients or payors.

The computer systems shown in FIG. 1 can be broken into four groups: client computer system 22, merchant computer system 24, ATM debit network 26, and transaction computer system 28. The client computer system 22 may also be referred to (i.e., is equivalent to) a buyer computer system of a buyer or a payor computer system of a payor. Similarly, the merchant computer system 24 may also be referred to (i.e., is equivalent to) a merchant web site, a seller computer system or seller web site of a seller, or a payee computer system or payee web site of a payee. In other words, for whatever reason (e.g., electronic commerce, business deal, purchase, bill payment, personal transaction, money transfer), the client (payor) desires to or needs to make a payment to the merchant (payee). The most common use of the system 20 will probably be electronic commerce for the sale of goods or services over the Internet, which continues to be a rapidly growing way to shop and do business. The client computer system 22 may be located virtually anywhere in the world due to the numerous available ways of electronic communication, such as telephone wires to a client's home, high-speed digital access lines to an office, fiber optic cable networks, wireless laptops, wireless palm-size computers, cellular telephones, and satellite communication devices.

The merchant computer system 24 will typically be a server that provides code and data (e.g., HTML, SGML, XML, Java Applets, image files) to generated a merchant web site that can be accessed by the client via the Internet 30. Hence, the client computer system 22 can be communicably connected to the merchant web site 24 via the Internet 30.

In FIG. 1, the arrows show how the components of the system are communicably coupled together as needed. The client computer system 22 and the merchant web site 24 are communicably coupled via the Internet 30. The merchant computer system 24 may be communicably coupled to the transaction computer system 28, for example, via the Internet or via a direct dial-up line.

The transaction computer system 28 of the preferred embodiment comprises a gateway server 32, a business server 34, a database server 36, and a certifying authority server 38. The gateway server 32 has software for receiving, routing, and communicating among the various components. The database server 36 in this example is an Oracle 8i database server, which is used to store information generated for and during the ATM debit transactions. The gateway server 32 is communicably coupled to the ATM debit network 26 as needed to submit debit requests or fund transfer requests to the bank or financial institution where the client has a bank account associated with the client's ATM debit card. The certifying authority server 38 is a server that is physically located in a secure facility of a trusted third-party (certifying authority's facility). The certifying authority issues and authenticates digital certificates. By authenticating the digital certificate of a merchant web site 24 through the certifying authority, the buyer can be confident that the merchant web site 24 is really that of the actual merchant, and not that of an imposter. Similarly, by authenticating the digital certificate or digital signature of a buyer, the merchant can be confident that the buyer is really the actual buyer or someone authorized by the buyer to use the buyer's computer system 22 and the buyer's ATM debit card.

The business server 34 of the transaction computer system 28 is adapted send and receive email messages for the transaction computer system (e.g., generating and sending email receipts to a buyer) and to provide code and data for a web site of the provider 40 of the online ATM transaction services. The preferred embodiment shown in FIG. 1 is just one possible configuration for a system in accordance with the present invention, and the configuration may vary. For example, in the preferred embodiment the gateway server 32, business server 34, and database server 36 are located at the physical facilities of the online ATM transaction service provider 40. However, these servers may be located at different locations while still being capable of being communicably coupled together to acts as the transaction computer system 28. Also, there may be multiple business servers 34, multiple gateway servers 32, and/or multiple database servers 36 for a larger scale operation of the system 20, each of which may be all in one building or distributed in multiple buildings or in multiple locations across the nation or across the world. In other words, the transaction computer system 28 is fully scaleable and modular.

Furthermore, in another embodiment, the certifying authority 38 may also be the provider of the online ATM transaction services 40. Hence, all of the components of the transaction computer system 28 may be at the certifying authority's facilities. In alternative, the transaction computer system 28 may be split different ways or different combinations. For example, the database server 36 and the certifying authority server 38 may be located at and maintained at the certifying authority's building. In another embodiment, the online ATM transaction service provider 40 may also act as the certifying authority, and hence the entire transaction computer system 28 may be all located within the provider's facility 40. As computer hardware and software capabilities continue to progress, the number of ways to provide a transaction computer system 28 of the present invention will likely also progress accordingly. For example, in yet another embodiment, the functions and tasks of the certifying authority server 38, the database server 36, the gateway server 32, and the business server 34 may all be provided by and performed on a single computer machine (i.e., in the same rack, or perhaps even within the same box or rack component). Thus, the tasks and components of the transaction computer system 28 of an embodiment of the present invention can be split-up, consolidated, or combined in numerous ways while still performing the same or equivalent core functions of the present invention.

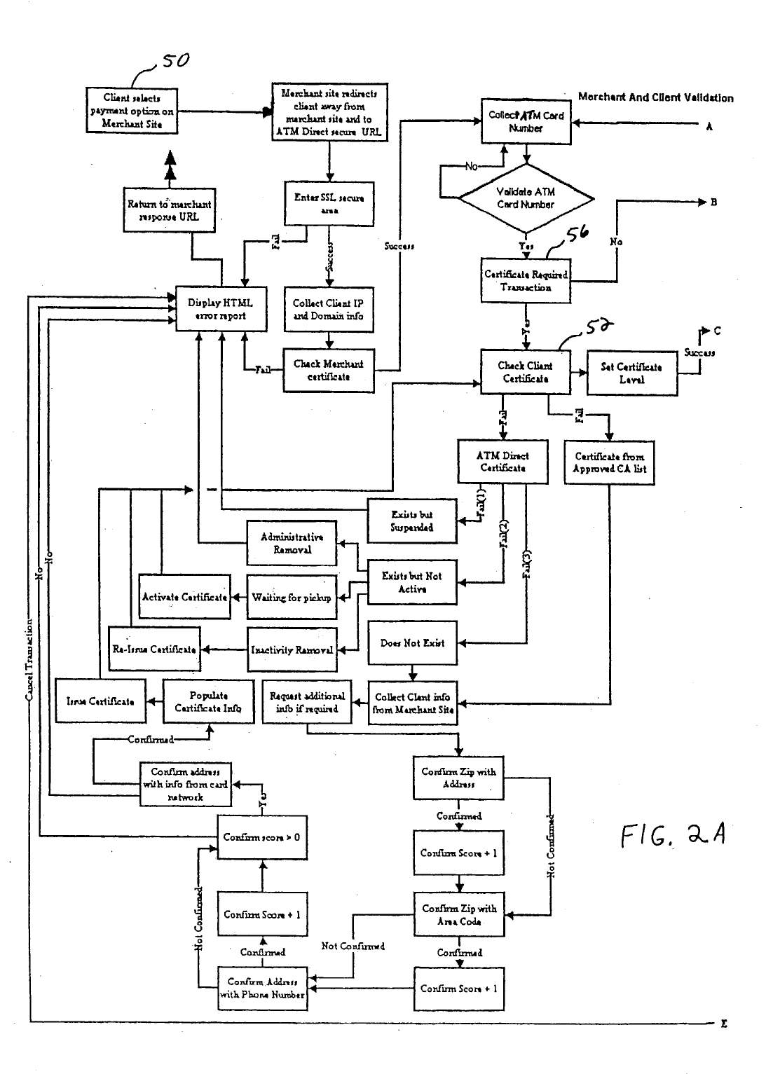

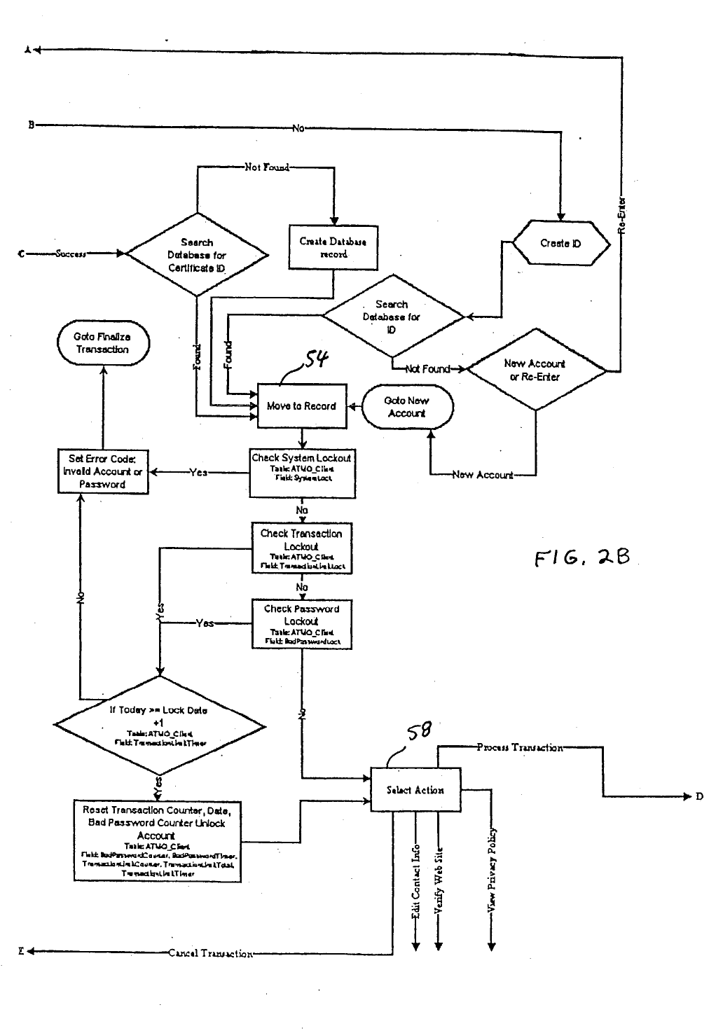

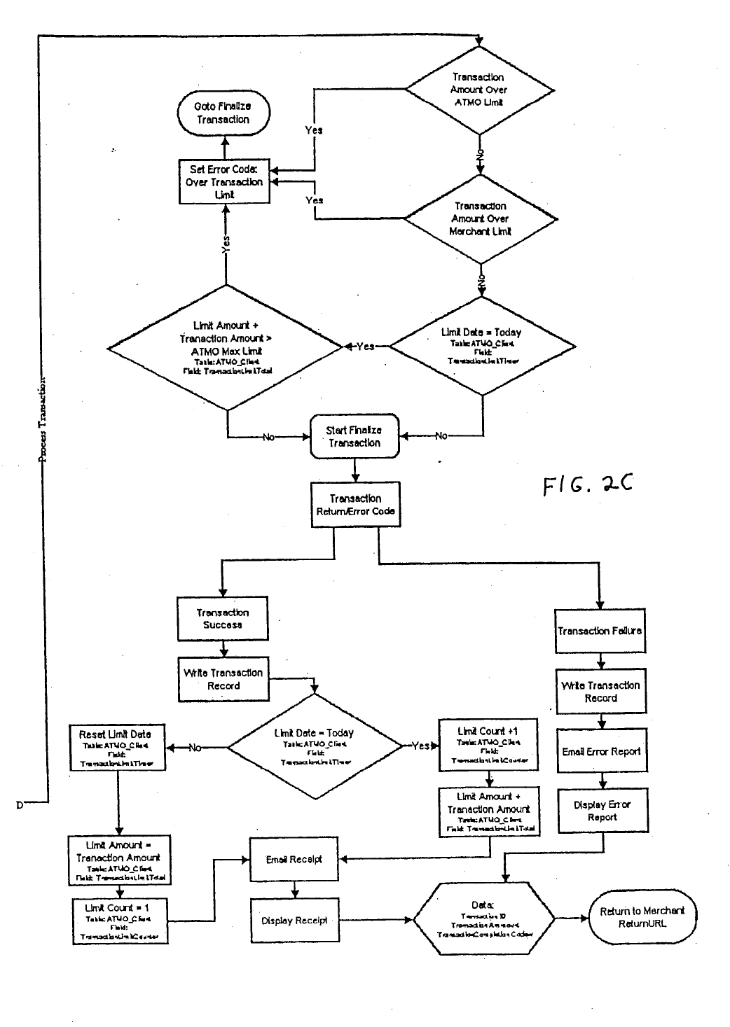

As a preface to the subsequent discussion regarding the flow chart schematic of FIGS. 2A-2C, the following description describes an example scenario of an electronic commerce transaction over the Internet in accordance with the present invention and focuses on the encryption aspects of such a transaction to illustrate a possible use of encryption technology to securely exchange information and the digital certificates when applying the present invention. Suppose Joe Buyer (the buyer) desires to purchase a gadget from Gadget Seller, Inc. (the seller) securely over the Internet using an ATM debit card in accordance with the present invention. In a method of selling the gadget to the buyer over the Internet in accordance with the present invention, the buyer's identity and the seller's identity will be verified and authenticated through the use of digital certificates. When the buyer selects an ATM debit card payment option, the seller transfers the buyer to a transaction computer system of a transaction service provider, which may be that of the seller or that of a third party. The buyer's computer and the transaction computer system establish an secure socket layer (SSL) connection, or any other equivalent standard secure connection. After obtaining the symmetric session key, the buyer and provider can send each other messages or information encrypted with symmetric session key, and hence an SSL connection is established. It is preferable to send and receive large amounts of data or information that is symmetrically encrypted rather than being asymmetrically encrypted because symmetric encryption and decryption is faster and consumes less processor effort. But the asymmetric encryption is useful in managing the secure delivery of the symmetric session key.

The buyer needs to securely transmit the buyer's bank account information (e.g., ATM debit card number, bank account number, PIN) to the provider. The buyer creates a hash code of the buyer's information using a standard hash function and encrypts the hash code with the symmetric session key. The hash code will be used by the provider to verify that the information sent by the buyer has not been altered along the way. The buyer also encrypts the buyer's information with the symmetric session key. The buyer then creates a package including the symmetrically encrypted information, the symmetrically encrypted hash code of the information, and the buyer's digital certificate. The buyer then digitally signs the package (i.e., asymmetrically encrypts the package with the buyer's private key) and sends the asymmetrically encrypted package to the provider. The provider can only asymmetrically decrypt the package using the buyer's public key, which proves to the provider that only the buyer could have sent it because only the buyer has the corresponding private key. Next, the provider decrypts the information and hash code using the symmetric session key. Thus, at this point the provider has the buyer's account information, the corresponding hash code, and the buyer's digital certificate.

The provider then rehashes the buyer's account information and compares the two hash codes of the buyer's account information to verify that the buyer's account information has not changed since it was transmitted by the buyer, i.e., verifying that the information was not corrupted or tampered with.

If the buyer does not have a valid digital certificate before entering into the ATM debit transaction over the Internet, the transaction computer system can direct the buyer to a certifying authority to obtain one. A digital certificate issued by a certificate authority to the buyer will typically include information about the buyer, an expiration date or validity period, a serial number, and the issuing certificate authority's information (i.e., name of certificate authority, etc.). The digital certificate issued by the certificate authority is signed by the certificate authority. That is, the certificate authority encrypts the buyer's digital certificate with the certificate authority's private key, and thus the buyer's digital certificate can only be decrypted and read with the certificate authority's public key. Hence, anyone opening the buyer's digital certificate will know that only the certificate authority, who is a trusted third party, could have issued it because only the certificate authority has the corresponding private key.

In obtaining a digital certificate from a certificate authority, the buyer will likely establish a secure connection (e.g., SSL connection) with the certificate authority, provide the requisite information to the certificate authority for obtaining a digital certificate, and securely receive the digital certificate from the certificate authority using encryption before transmission. The seller can obtain a digital certificate from a certificate authority, just as described for the buyer, so that the seller can provide its digital certificate to authenticate its identity for a buyer or a banking institute. Back to the transaction discussion, the provider now needs to decrypt and verify the buyer's digital certificate. If the provider does not already have the certificate authority's public key, the provider next obtains the certificate authority's public key. With the certificate authority's public key, the provider decrypts the buyer's digital certificate. The provider determines whether the digital certificate is still valid and whether there are any specific restrictions on the digital certificate relevant to the transaction. Also, the provider compares the information from the buyer's digital certificate with the information provided by the buyer to determine if they match. Because the provider trusts the certificate authority and because the buyer signed the information sent to the provider, the provider can authenticate that the buyer is really who he/she/it claims to be. Likewise, the provider can authenticate the identity of the seller by obtaining and decrypting the seller's digital certificate via encrypted communications. Thus, the use of digital certificates allows the provider to authenticate the identity of the buyer and the seller, which will ideally safeguard both parties from fraud. Now that the identities of the transaction parties' has been authenticated by the provider, the provider can proceed to execute the ATM debit transaction by communicating with the relevant financial institution(s) and/or bank(s) via the ATM debit network.

FIGS. 2A-2C show a flow chart schematic of a business method or process in accordance with the preferred embodiment of the present invention. Because the preface above focuses on encryption processes that may be used in applying the present invention, the following description focuses on other aspects of the preferred embodiment and progresses through the flow chart schematic of FIGS. 2A-2C. The process shown in FIGS. 2A-2C is adapted to run on the system shown in FIG. 1. However, as will be apparent to one having ordinary skill in the art with the benefit of this disclosure, other possible variations in the process are possible while performing the same or equivalent tasks or core functions of the present invention. For example, some of the details of how certain tasks are handled, when a transaction is terminated, or what order the steps are in may vary while still providing an ATM transaction over the Internet using at least one digital certificate to authenticate the identity of at least one party to the transaction.

Starting at the “Client selects payment option on Merchant Site” box 50 in the upper left corner of FIG. 2A, the process can be understood by following the logic sequences and paths of the arrows shown connecting the action, query, or decision boxes in FIGS. 2A-2C. When a buyer or client selects an option to pay using an ATM debit card (or payment by withdrawal from a bank account) on the merchant web site (e.g., when checking out after shopping and selecting items to purchase), the merchant computer system 24 redirects the buyer away from the merchant web site and to a site generated by the transaction computer system 28. At this point the transaction computer system 28 establishes a secure connection between the buyer computer system 22 and the transaction computer system 28, such as a secure socket layer (SSL) connection. If the SSL connection is not successful in providing a secure connection, the transaction computer system 28 sends an HTML error message to the buyer's browser 22 and the buyer is returned to the merchant web site 24. If the SSL secure connection is successful, the transaction computer system 28 collects the buyer's Internet Protocol (IP) address and domain information. Next, the transaction computer system 28 checks the merchant's digital certificate to verify and authenticate the identity of the merchant compared to the identity claimed by the merchant. If the merchant's digital certificate cannot be authenticated, an HTML error message is sent to the buyer and the buyer is returned to the merchant web site 24. In other words, the ATM debit transaction is canceled because the merchant's digital certificate was not authenticated. Thus there is either an error or problem with the merchant's digital certificate (e.g., it may have expired), or the supposed merchant is an imposter trying to commit a fraud using the identity or name of the actual merchant. Hence, the buyer can be protected from fraud by this part of the process through the use of digital certificate technology.

If the merchant digital certificate is authenticated (i.e., the certificate is valid and the merchant is legitimate according to the certificate), the transaction computer system 28 then collects a bank account number, which corresponds to a bank account (e.g., checking, savings). The bank account number may be the ATM debit card number stamped on an ATM debit card, which corresponds to one or more bank accounts. Often an ATM debit card number will differ from a checking account number, even though both number may correspond to the same bank account. Next the transaction computer system 28 validates the ATM debit card number, which may require interaction the bank via the ATM debit network 26. If the ATM debit card number is not valid (e.g., closed account, non-existent account), the transaction computer system 28 requests the ATM debit card number again (e.g., in case the number was entered wrong). For entering the ATM debit card number, the buyer's computer system 22 may have a card swiping device that will read a magnetic strip on the ATM debit card to input the ATM debit card number information, or the buyer may just type in the ATM debit card number, which is typically stamped on the card. The buyer may input the ATM debit card number using a keyboard and/or using a mouse interacting with a virtual keypad or keyboard (graphical user interface) displayed on the buyer's computer system (e.g., buyer's browser). Upon repeated tries, if the ATM debit card number still cannot be validated, then an HTML error message can be generated and sent to the buyer's browser, and the ATM transaction is terminated.

If the buyer's ATM debit card number is validated, then the transaction computer system 28 determines whether the ATM debit transaction at hand requires a digital certificate from the buyer. Such consideration may be based, for example, on the rules for the buyer's bank account usage or it may be based on the dollar value involved (e.g., for transactions exceeding $200). If a digital certificate is required from the buyer, then the transaction computer system 28 requests and/or receives a digital certificate from the buyer. If or when the buyer has a digital certificate that the transaction computer system 28 can open or access, then the transaction computer system 28 attempts to authenticate the buyer digital certificate. If the buyer digital certificate cannot be authenticated because it exists but has been suspended, then an HTML error message is sent to the buyer, the ATM debit transaction is terminated, and the buyer is returned to the merchant's web site. If the buyer digital certificate cannot be authenticated because it exists but is not active, then the transaction computer system 28: 1) performs an administrative removal, sends an HTML error message to the buyer, terminates the ATM debit transaction, and returns the buyer to the merchant's web site; 2) activates the certificate if it determines that the digital certificate was awaiting the buyer to pick it up or retrieve it, and returns to the action 52 of checking the buyer digital certificate; or 3) re-issues a digital certificate to the buyer if it determines that the digital certificate was removed for being inactive, and returns to the action 52 of checking the buyer digital certificate.

If the buyer does not have a digital certificate yet or if for some reason the transaction computer system 28 cannot open or access the buyer digital certificate, then the transaction computer system 28 can attempt to issue the buyer a new digital certificate. In attempting to issue the buyer a new digital certificate, the transaction computer system 28 collects any relevant client information already provided to the merchant computer system 24 via the merchant web site. Then, the transaction computer system 28 requests additional information if needed. The transaction computer system 28 attempts to confirm the zip code with the buyer's address information. If confirmed, one point is added to a score variable that starts as zero. If not confirmed, the transaction computer system 28 attempts to confirm the zip code with the area code of the buyer's phone number. If confirmed, one point is added to the score variable. If not confirmed, the transaction computer system 28 attempts to confirm the address with the buyer's phone number. If confirmed, one point is added to the score variable. If not confirmed, no points are added to the score. Next, the transaction computer system 28 determines whether the score is greater than one, which indicates whether any of the confirmation tests added a point to the score. If the score is not greater than zero, then the transaction computer system 28 sends an HTML error message to the buyer, terminates the ATM debit transaction, and returns the buyer to the merchant's web site. If the score is greater than zero, the transaction computer system 28 confirms the address information with information from the ATM debit network 26 regarding the buyer's bank account. If the address is not confirmed with the information provided from the ATM debit network 26, the transaction computer system 28 sends an HTML error message to the buyer, terminates the ATM debit transaction, and returns the buyer to the merchant's web site 24. If the address is confirmed with the information provided from the ATM debit network 26, the transaction computer system 28 populates the digital certificate with information about the buyer, issues a digital certificate to the buyer, and returns to the check buyer digital certificate action 52.

If or when the transactional computer system 28 authenticates the buyer digital certificate, the transaction computer system 28 sets the certificate level. Continuing on FIG. 2B, after the certificate level is set, the transaction computer system 28 searches its database 36 for the certificate identification number or some other certificate identifier. If the certificate is not found in the database server 36 or in the certifying authority server 38, a new database record is created and the new database record is sent for further processing (box 54). If the certificate is found in the transaction computer system 28 (i.e., a database record already exists for this certificate in database 36), the certificate record is retrieved and sent for further processing (box 54).

Referring again to FIG. 2A at the “Certificate Required Transaction” query box 56, if no certificate is required, then (continuing on FIG. 2B) the transaction computer system 28 creates an ID (identification) record for the buyer. The database 36 of the transaction computer system 28 is searched to determine whether a record matching the buyer's identification can found in the database 36. If the buyer's ID already exists in the database 36, then the record for the buyer is sent for further processing (box 54). If the buyer's ID cannot be found in the database, a new account or a re-entry account is generated, stored in the database, and sent for further processing (box 54).

Referring to box 54 in FIG. 2B, although it may have arrived from any of the paths described above, the buyer record is now ready for further processing. The database 36 of the transaction computer system 28 tracks and stores records of past transactions for each user or buyer by record ID. Next, the transaction computer system 28 checks for system lockouts for the buyer of record. If there has been a system lockout, the transaction computer system 28 sets an error code of invalid account or invalid password and the transaction is canceled, terminated, or finalized without completion. If there have been no system lockouts, the transaction computer system 28 next checks for whether there have been transaction lockouts for the buyer of record. If there have been no transaction lockouts, the transaction computer system 28 further checks for whether there have been password lockouts for the buyer of record.

If there has been a transaction lockout or a password lockout for the buyer of record, the transaction computer system 28 next determines whether there has been one or more transaction lockout or password lockout on that day. If there has been a transaction lockout or password lockout on that day, the transaction computer system 28 sets an error code of invalid account or invalid password and the transaction is canceled, terminated, or finalized without completion. If there have been no transaction lockouts or password lockouts on that day, then the transaction computer system 28 resets the transaction counter, date, and bad password counter unlock account settings for the record of the buyer, and progresses to the “Select Action” box 58. Also, if the buyer record indicates that there have been no system lockouts, no transaction lockouts, and no password lockouts, then the process progresses to the “Select Action” box 58. One purpose of these checks is to try to prevent hackers or other persons attempting to commit fraud from passing through and completing an ATM debit transaction. In other words, it is for the protection of legitimate buyers and those who may have had there information taken or used without permission.

Referring to the “Select Action” box 58 in FIG. 2B, at this point one of the actions is selected: process transaction; cancel transaction; edit contract information; verify web site; or view privacy policy. If cancel transaction is selected (see path E continued on FIG. 2A), an HTML error message is sent to the buyer, the ATM debit transaction is terminated, and the buyer is returned to the merchant's web site. If the process transaction action is selected (see path D continued on FIG. 2C), then the ATM debit transaction proceeds. Next, the transaction computer system 28 determines whether the amount to be debited is over the limit, which may be determined by each bank for a given bank account, by the balance in the bank account available for withdrawal, or by some other rules or regulations. If the transaction amount is over the limit, an error code is sent to the buyer's browser 22 to inform the buyer that the transaction amount is over the limit and the transaction is ended. If the transaction amount is not over the limit, the transaction computer system 28 next determines whether the transaction amount is over the merchant's limit, which may vary from merchant to merchant. If the transaction amount is over the merchant's limit, an error code is sent to the buyer's browser 22 to inform the buyer that the transaction amount is over the merchant's limit and the transaction is ended. If the transaction amount is not over the merchant's limit, the transaction computer system 28 next determines whether the transaction amount exceeds the limit for that day. For example, there may be a limit to the amount of purchases that may be made using the ATM debit card per day, which may be set by each bank for a given bank account, by the online ATM transaction service provider 40, or by some other rules or regulations. Such checks are put in place because often when bank account information is stolen, the thief will try to charge as much as possible, as quickly as possible before the owner of the bank account realizes that his or her ATM debit card or check book is missing. If an ATM debit transaction has occurred on that day already, the transaction computer system 28 compares the prior transaction amounts for that day plus the proposed transaction amount to the limit set per day for that bank account. If the transactions for the day plus the proposed transactions exceed the limit per day, then an error code is sent to the buyer's browser 22 to inform the buyer that the transaction amount will go over the daily limit and the transaction is ended.

If there have been no ATM debit transactions for that account on that day, and if there have been transactions that day and the limit will not be exceeded by the proposed transaction, then the transaction computer system 28 starts to finalize the transaction. At this point the transaction computer system 28 makes a request from the respective bank of the bank account via the ATM debit network 26. If the transaction fails at this stage (i.e., bank server down, problem at bank, restriction set by bank, etc.), then a failure code is sent back to the transaction computer system 28 via the ATM debit network 26. Upon notice of failure, the transaction computer system 28 writes to the transaction record on the database 36 to update it, emails an error report to the buyer, displays an error report on the buyer's browser 22, and returns the buyer to the merchant's web site 24.

If the transaction is successful, a success code is sent back to the transaction computer system 28 via the ATM debit network 26. Upon notice of a successful ATM debit transaction, the transaction computer system 28 writes to the transaction record on the database 36 to update it. If the most recent limit date of record for the bank account at hand is the same as the day of the transaction just completed, then the limit counter is increased by one and the current transaction amount is added to the prior limit amount to update the limit amount in light of the current transaction. If the most recent limit date differs from the current date of the transaction at hand, then the transaction computer system resets the limit date to the current date of the transaction at hand, the limit amount is reset to equal the current transaction amount, and the limit counter is reset to equal one. After the transaction computer system 28 is finished updating the database 36, the transaction computer system 28 sends an email receipt to the buyer, and displays a receipt on the buyer's browser 22. At this point, a successful and secure ATM debit transaction is completed over the Internet so that the buyer can pay the merchant using an ATM debit card for the electronic commerce transaction (e.g., sale of goods or services over the Internet).

The present invention can be used in a number of online applications, including but not limited to: purchasing lottery tickets over the Internet; playing casino games over the Internet; gambling over the Internet; sending money to friends or relatives in distant places over the Internet; buying groceries (to be delivered) over the Internet; buying books, videos, music, or software (to be delivered) over the Internet; paying for or bidding on items in an online auction; purchasing movies to view via the Internet; donating money to a charity organization over the Internet; downloading digital books, music, images, video clips, graphics, games, or software over the Internet; paying bills (e.g., electric, mortgage, phone, cable, rent, ISP services, credit card statements) over the Internet; or buying real estate over the Internet. Therefore, the present invention provides a way for buyers, banks, and sellers to all have the confidence that an ATM debit transaction over the Internet can be completed securely and with less chances for fraud to occur.

It will be appreciated by those skilled in the art having the benefit of this disclosure that this invention provides a system and method of authenticating and processing an ATM debit or bank account withdrawal transaction over the Internet using at least one digital certificate to authenticate the identity of at least one party to the transaction. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

Any element or limitation in a claim that does not explicitly state or use the language of “means for” performing a specified function, or “step for” performing a specified function, is not to be construed or interpreted as a “means” or “step” clause under 35 U.S.C. § 112, sixth paragraph, and thus should not invoke 35 U.S.C. § 112, sixth paragraph. In particular, the use of “step of” or “steps of” in the preamble of the method claims herein are not intended to invoke the application of 35 U.S.C. § 112, sixth paragraph.

Although the preferred embodiment has been described in detail, it should be understood that various changes, substitutions and alterations can be made therein without departing from the spirit and scope of the invention as defined by the appended claims.

1. A system for performing an ATM debit transaction over the Internet, comprising:
a transaction computer system adapted to be communicably coupled to each of a payee computer system and an ATM debit network as needed during said ATM debit transaction, said transaction computer system having software adapted to authenticate an identity of a payor using a payor digital certificate provided by said payor and adapted to debit funds from a bank account of said payor via said ATM debit network if said identity of said payor is authenticated by a decryption of said payor digital certificate.

2. A system in accordance with claim 1, wherein said transaction computer system further comprises software adapted to authenticate an identity of a payee using a payee digital certificate provided by said payee and adapted to deposit said debited funds in an account of said payee.

3. A system in accordance with claim 1, wherein said software comprises plural subprograms that can be called upon by said software program as needed.

4. A system in accordance with claim 1, wherein said software runs and resides on a single computer machine.

5. A system in accordance with claim 1, wherein said transaction computer system is a single computer machine at a single physical location.

6. A system in accordance with claim 1, wherein said transaction computer system comprises plural computer machines.

7. A system in accordance with claim 6, wherein said software comprises plural components distributed on said plural computer machines of said transaction computer system.

8. A system in accordance with claim 6, wherein said plural computer machines of said transaction computer system are distributed among different physical locations.

9. A system in accordance with claim 6, wherein said plural computer machines of said transaction computer system reside in a single building.

10. A system in accordance with claim 1, wherein said transaction computer system comprises a gateway server, a certificate authority server, a business server, and a database server.

11. A system in accordance with claim 1, wherein said payor digital certificate exchange involves an asymmetric cryptography process.

12. A system for transacting electronic commerce payments over the Internet, comprising:
a bank account debit network linking together a plurality of financial institutions;
a payee computer system communicably coupled to the Internet;
a payor computer system communicably coupled to the Internet, such that said payor computer system can be communicably coupled to said payee computer system via the Internet;
a transaction computer system communicably coupled to said payee computer system and said bank account debit network; and
a software program on said transaction computer system adapted to authorize a bank account debit transaction between said payee computer system and said payor computer system using at least one digital certificate exchange for at least partial authorization of said bank account debit transaction, and said software program being adapted to submit said bank account debit transaction to said bank account debit network for debiting money from a bank account of a payor if said bank account debit transaction has been authenticated and authorized using said at least one digital certificate exchange.

13. A system in accordance with claim 12, wherein said bank account debit network is an ATM debit network.

14. A system in accordance with claim 12, wherein said software program comprises plural subprograms that can be called upon by said software program as needed.

15. A system in accordance with claim 12, wherein said software program runs and resides on a single computer machine.

16. A system in accordance with claim 12, wherein said transaction computer system is a single computer machine at a single physical location.

17. A system in accordance with claim 12, wherein said transaction computer system comprises plural computer machines.

18. A system in accordance with claim 17, wherein said software comprises plural components distributed on said plural computer machines of said transaction computer system.

19. A system in accordance with claim 17, wherein said plural computer machines of said transaction computer system are distributed among different physical locations.

20. A system in accordance with claim 17, wherein said plural computer machines of said transaction computer system reside in a single building.

21. A system in accordance with claim 12, wherein said transaction computer system comprises a gateway server, a certificate authority server, a business server, and a database server.

22. A system in accordance with claim 12, wherein said at least one digital certificate exchange involves an asymmetric cryptography process.

23. A system in accordance with claim 12, wherein said at least one digital certificate exchange involves the submission of a payee digital certificate to said transaction computer system and submission of a payor digital certificate to said transaction computer system to authenticate the identity of parties to said bank account debit transaction.

24. A system for performing a secure ATM transaction for a buyer making a payment to a seller over the Internet, comprising:
an ATM network linking together a plurality of banks;
a seller web site accessible to said buyer via the Internet;
a transaction computer system adapted to be communicably coupled to said seller web site and said ATM network as needed to perform said secure ATM transaction; and
a software program on said transaction computer system adapted to authorize and facilitate said secure ATM transaction between said seller and said buyer using at least one digital certificate to verify the identity of at least one of said buyer and said seller, and when said secure ATM transaction is authorized, said software program being adapted to submit a debit request to said ATM network corresponding to said secure ATM transaction.

25. A system in accordance with claim 24, wherein said at least one digital certificate exchange involves asymmetric cryptography.

26. A system in accordance with claim 24, wherein said at least one digital certificate exchange involves the submission of a seller digital certificate to said transaction computer system and submission of a buyer digital certificate to said transaction computer system to authenticate the identity of both parties to said secure ATM transaction over the Internet.

27. A system for authenticating identities of parties to an ATM debit transaction occurring over the Internet, comprising:
a transaction computer system located remotely from a first computer system of a first party to said ATM debit transaction, said transaction computer system comprising a software program adapted to authenticate the identity of said first party using a digital certificate presented to said transaction computer system by said first party, wherein said transaction computer system is adapted to be communicably coupled to an ATM debit network as needed, wherein said first computer system is adapted to be communicably coupled to said transaction computer system as needed, and wherein a second computer system of a second party to said ATM debit transaction communicates with said first computer system via the Internet when said ATM debit transaction is initiated.

28. A system in accordance with claim 27, wherein said first party is a buyer and said second party is a seller.

29. A system in accordance with claim 27, wherein said first party is a seller and said second party is a buyer.

30. A system in accordance with claim 27, wherein said use of said digital certificate involves asymmetric cryptography.

31. A method of performing a bank account debit transaction over the Internet, comprising the steps of:
requiring a payor to provide a payor digital certificate that can authenticate the identity of said payor;
verifying the authenticity of said payor digital certificate on a transaction computer system; and
if said payor digital certificate is authenticated, debiting funds from a bank account of said payor via a bank account debit network, wherein said transaction computer system is communicably coupled to said bank account debit network as needed during said debiting step.

32. A method in accordance with claim 31, wherein said payor is a buyer purchasing goods or services from a web site.

33. A method in accordance with claim 31, wherein said payor is a person or entity paying a bill over the Internet.

34. A method in accordance with claim 31, wherein said payor is a person or entity subscribing to at least one of a magazine, journal, newspaper, and news service over the Internet.

35. A method in accordance with claim 31, wherein said payor is person purchasing a lottery ticket over the Internet.

36. A method in accordance with claim 31, wherein said payor is a person playing a casino game over the Internet.

37. A method in accordance with claim 31, wherein said payor is a person gambling over the Internet.

38. A method in accordance with claim 31, wherein said payor is a person or entity sending money to another person or entity over the Internet.

39. A method in accordance with claim 31, wherein said payor is a person or entity buying groceries over the Internet.

40. A method in accordance with claim 31, wherein said payor is a person or entity buying at least one of a book, video, music recording, game, and software program over the Internet that will be delivered to said person or entity by parcel deliver.

41. A method in accordance with claim 31, wherein said payor is a person or entity paying for or bidding on items in an online auction over the Internet.

42. A method in accordance with claim 31, wherein said payor is a person or entity purchasing a movie to view via the Internet.

43. A method in accordance with claim 31, wherein said payor is a person or entity donating money to a charity organization over the Internet.

44. A method in accordance with claim 31, wherein said payor is a person or entity downloading at least one of a digital book, music file, image file, video clip, graphic art clip, game, and software program over the Internet.

45. A method in accordance with claim 31, wherein said payor is a person or entity buying real estate over the Internet.

46. A method in accordance with claim 31, further comprising the steps of:
requiring a payee to provide a payee digital certificate that can authenticate the identity of said payee;
verifying the authenticity of said payee digital certificate on said transaction computer system; and
if said payee digital certificate is authenticated, transferring said debited funds to an account of said payee.

47. A method in accordance with claim 46, wherein said payee is a seller and said payor is a buyer purchasing at least one of a good, service, personal property, and real property from a web site of said seller over the Internet.

48. A method in accordance with claim 31, wherein at least part of said bank account debit transaction occurs via an ATM debit network.

49. A method in accordance with claim 31, wherein said verifying the authenticity step involves the use of at least one cryptography algorithm.

50. A method in accordance with claim 31, wherein said verifying the authenticity step involves the use of Public Key Infrastructure (PKI) for distributing at least one public key over the Internet.

51. A method in accordance with claim 31, wherein said payor digital certificate is encrypted using a public-private key pair, and wherein said verifying the authenticity step comprises a step of decrypting said buyer digital certificate at said transaction computer system using a public key of a certificate authority.

52. A method in accordance with claim 31, wherein said verifying the authenticity step involves the use of asymmetric cryptography.

53. A method of performing a bank account debit transaction over the Internet, comprising the steps of:
debiting funds from a bank account of a payor via a bank account debit network;
requiring a payee to provide a payee digital certificate that can authenticate the identity of said payee;
verifying the authenticity of said payee digital certificate on a transaction computer system; and
if said payee digital certificate is authenticated, transferring said debited funds into an account of said payee.

54. A method of purchasing at least one of a product, service, or property from a seller via the Internet with an ATM debit card, without requiring a buyer and said ATM debit card to be physically present at a machine, employee, or facility of said seller, comprising the steps of:
when said buyer selects a debit card payment option to pay for said at least one product, service, or property offered on a seller web site, requiring said buyer to provide a buyer digital certificate to authenticate the identity of said buyer;
verifying the authenticity of said buyer digital certificate;
if said buyer digital certificate is authenticated, debiting funds from a bank account associated with said ATM debit card via an ATM debit network; and
transferring said debited funds to an account of said seller as payment for said at least one product or service purchased by said buyer from said seller web site over the Internet.

55. A method of selling at least one of a product, service, or property via the Internet, comprising the steps of:
providing a seller web site that a buyer can access via the Internet;
providing a transaction computer system, wherein said transaction computer system is adapted to be communicably coupled to a seller computer system as needed, wherein said seller computer system comprises code and data adapted to provide said seller web site, and wherein said transaction computer system is adapted to be communicably coupled to a bank account debit network;
when a buyer selects a debit card payment option for an electronic commerce transaction to purchase said at least one product, service, or property offered on said seller web site, initiating a debit transaction on said transaction computer system;
sending a seller digital certificate to said transaction computer system for verification of the identity of said seller;
determining whether said seller digital certificate is authentic by decrypting said seller digital certificate at said transaction computer system;
collecting a bank account number for a bank account of said buyer;
determine whether said bank account number is valid;
collecting a buyer digital certificate for verification of the identity of said buyer;
determining whether said buyer digital certificate is authentic by decrypting said buyer digital certificate at said transaction computer system;
if said buyer digital certificate and said seller digital certificate are authenticated, submitting said debit transaction to said bank account debit network;
debiting funds from said bank account of said buyer via said bank account debit network;
informing said seller computer system that said debit transaction was successfully executed so that said electronic commerce transaction can be completed; and
depositing said debited funds into an account of said seller.

56. A method in accordance with claim 55, further comprising the step of:
if said buyer does not have said buyer digital certificate, issuing said buyer digital certificate to said buyer so that said transaction can continue.

57. A method in accordance with claim 55, further comprising the step of:
collecting an Internet protocol address for said buyer.

58. A method in accordance with claim 55, further comprising the step of:
collecting domain information for said buyer.

59. A method in accordance with claim 55, further comprising the step of:
requiring said buyer to input a debit card number using a keyboard at a buyer computer system of said buyer.

60. A method in accordance with claim 55, further comprising the step of:
requiring said buyer to input a debit card number using a mouse and a number pad displayed on a graphical user interface on a buyer computer system of said buyer.

61. A method in accordance with claim 55, further comprising the steps of:
checking a database on said transaction computer system to determine whether said buyer has triggered a lockout based on prior activities of said buyer;
if said buyer has triggered said lockout, sending an error message to said buyer and terminating said debit transaction.

62. A method in accordance with claim 55, further comprising the steps of:
determining whether said debit transaction is permissible based on one or more prior transaction amounts and based on a current amount of said debit transaction;
if said debit transaction is not permissible, sending an error message to said buyer and terminating said debit transaction.
